(19) United States
(12) Patent Application Publication
(10) Pub. No.: US 2019/0059354 A1
(43) Pub. Date: Feb. 28, 2019

(54) Bristle worm trap for use in aquariums

(71) Applicant: Chuong V. Tong, Irvine, CA (US)

(72) Inventor: Chuong V. Tong, Irvine, CA (US)

(21) Appl. No.: 15/685,895

(22) Filed: Aug. 24, 2017

(51) Int. Cl. A01M 23/08; A01K 63/02; A01K 61/40

(52) U.S. Cl. CPC A01M 23/08; A01M 2200/00; A01K 61/40; A01K 63/02

(57) ABSTRACT

A bristle worm trap for catching bristle worms in an aquarium, includes a trap body, including a trap enclosure, a cap, a bait container, worm access points, each optionally with attached inner and outer access lines that can be funnels or tubes; and an elongated handle used for positioning the bristle worm trap in the aquarium; such that bristle worms crawl through the outer access line, the worm access point, and the inner access line, guided by a scent from a bait positioned in the bait container, and become trapped in the trap enclosure.

### CROSS-REFERENCE TO RELATED APPLICATIONS

N/A.

### FIELD OF THE INVENTION

The present invention relates generally to the field of accessories for aquariums, and more particularly to devices, systems, and methods and for trapping bristle worms in saltwater aquariums.

### BACKGROUND OF THE INVENTION

Bristle worms can be a nuisance for anyone maintaining a saltwater aquarium. There are devices available for removal of bristle worms, but these are generally difficult to use when positioning the device, and they are not sufficiently effective in trapping bristle worms.

As such, considering the foregoing, it may be appreciated that there continues to be a need for novel and improved devices and methods for trapping bristle worms in saltwater aquariums.

### SUMMARY OF THE INVENTION

The foregoing needs are met, to a great extent, by the present invention, wherein in aspects of this invention, enhancements are provided to the existing model of trapping bristle worms in saltwater aquariums.

In an aspect, a bristle worm trap for catching bristle worms in an aquarium, can include:
a) a trap body, including:
   a trap enclosure with an upper aperture that leads into an enclosure cavity;
   a cap, which is removably positioned on an upper part of the trap enclosure, such that the cap covers the upper aperture, and closes the enclosure cavity;
   a bait container, which can be mounted inside the trap body, wherein the bait container comprises a plurality of container apertures, which are configured to distribute a scent from a bait/attractant that is placed inside the bait container, such that the scent is distributed to the enclosure cavity;
   At least one or a plurality of worm access points, which are entry apertures in the trap enclosure, which provide access from an external environment to the enclosure cavity, such that bristle worms crawl through the access points, guided by the scent from the bait, and become trapped in the trap enclosure; wherein each worm access point, can further include:
      an inner access line, which is hollow and connects to an inner side of the worm access points, such that the bristle worms crawl through the inner access line into the trap enclosure, such that the inner access line prevent the bristle worms from escaping the trap enclosure;
      an outer access line, which is hollow and connects to an outer side of the worm access points, such that the bristle worms crawl through the outer access line and then trough the inner access line, to reach the trap enclosure;
b) An elongated handle, which is connected to the trap body, such that the elongated handle is flexible and configured to allow positioning of the trap body in the aquarium.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1A is a perspective view of a worm trap in use in an aquarium, according to an embodiment of the invention.

FIG. 1B is a perspective view of a worm trap in use in an aquarium, according to an embodiment of the invention.

FIG. 2A is a perspective view of a worm trap, according to an embodiment of the invention.

FIG. 2B is a perspective view of a worm trap, according to an embodiment of the invention.

FIG. 2C is a perspective view of a worm trap, according to an embodiment of the invention.

FIG. 3 is a perspective view of a worm trap, according to an embodiment of the invention.

FIG. 4 is a bottom perspective view of a worm trap, according to an embodiment of the invention.

FIG. 5 is a cross-sectional view of a part of a worm trap, according to an embodiment of the invention.

FIG. 6 is a perspective view of a worm trap, showing inner parts of the worm trap in dotted lines, according to an embodiment of the invention.

FIG. 7 is a side perspective sectional-cut view of a worm trap, showing inner parts of the worm trap, according to an embodiment of the invention.

FIG. 8A is a side perspective sectional-cut view of a worm trap, showing inner parts of the worm trap, according to an embodiment of the invention.

FIG. 8B is a perspective exploded view of a worm trap, showing parts of the worm trap, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

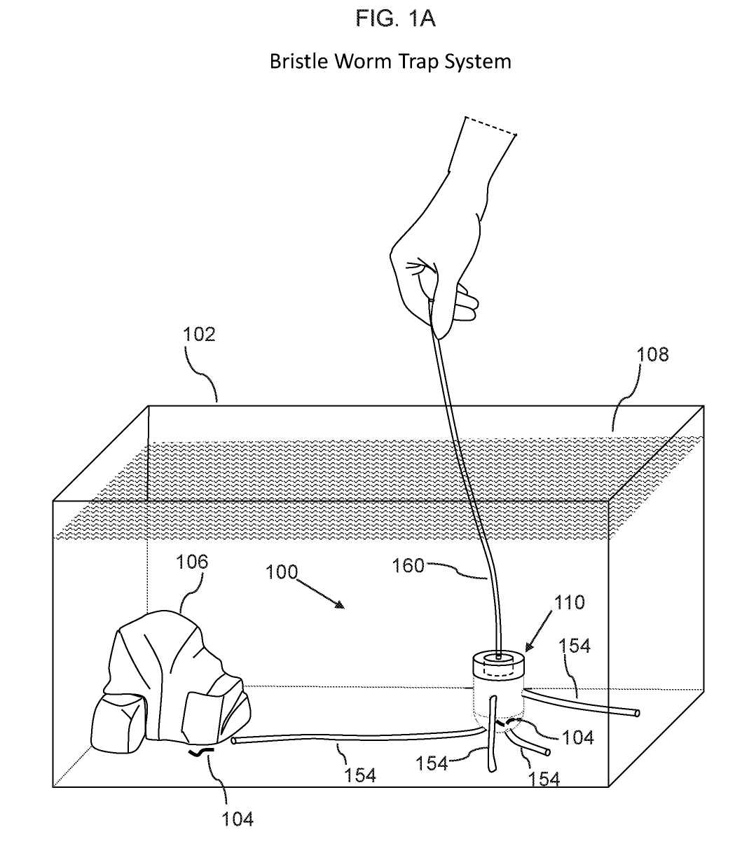

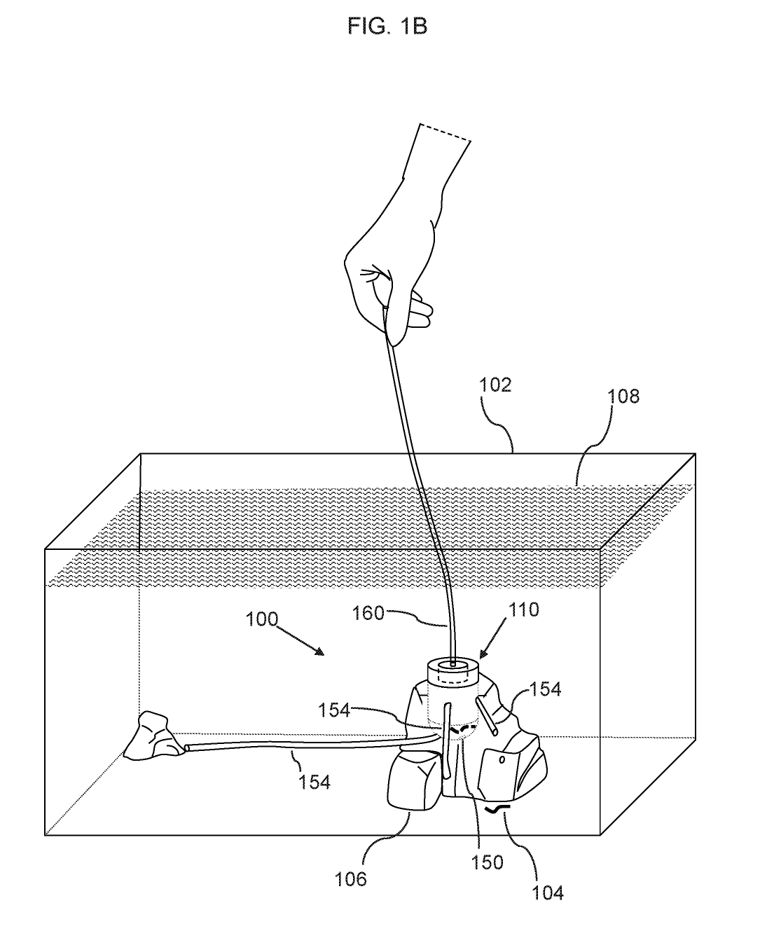

In the following, we describe the structure of an embodiment of a bristle worm trap 100 with reference to FIG. 1, in such manner that like reference numerals refer to like components throughout; a convention that we shall employ for the remainder of this specification.

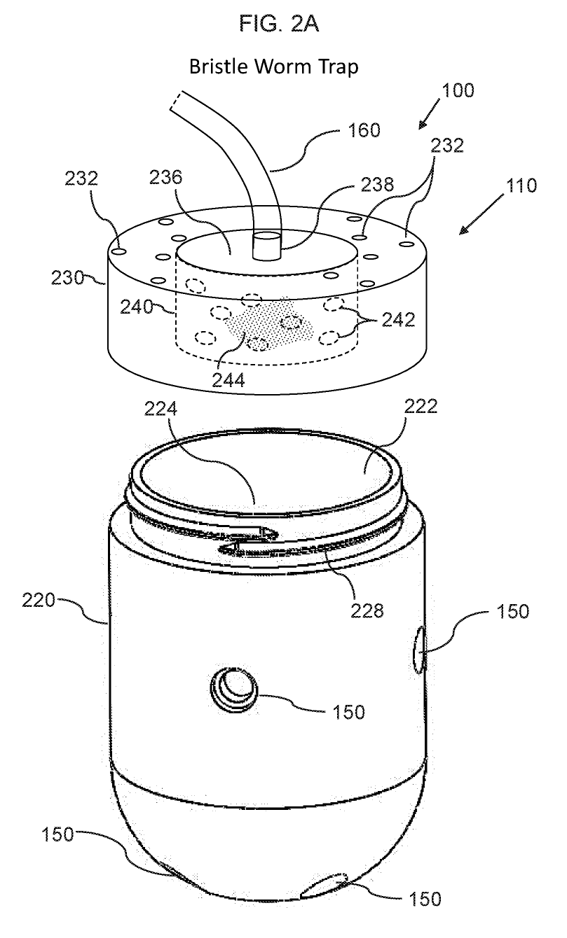

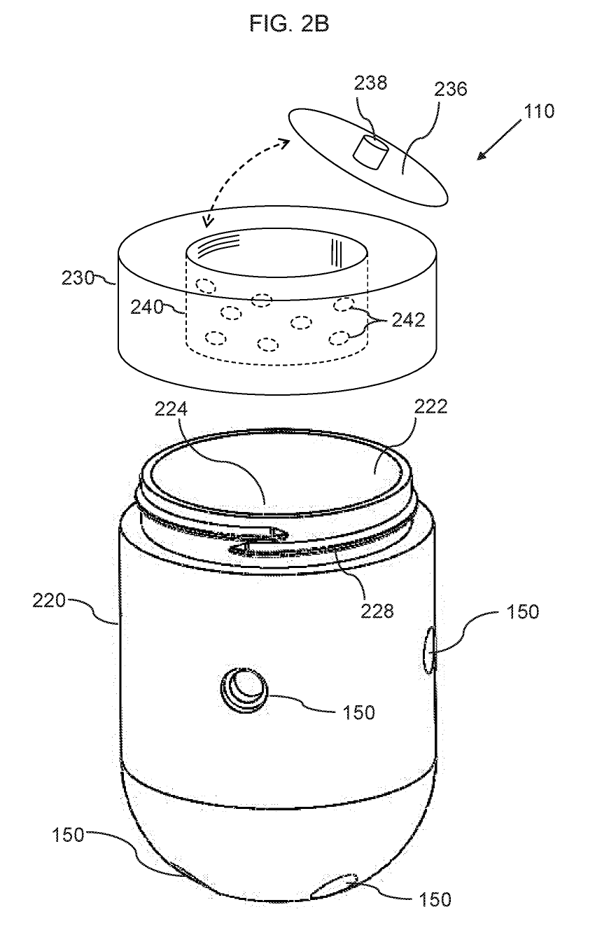

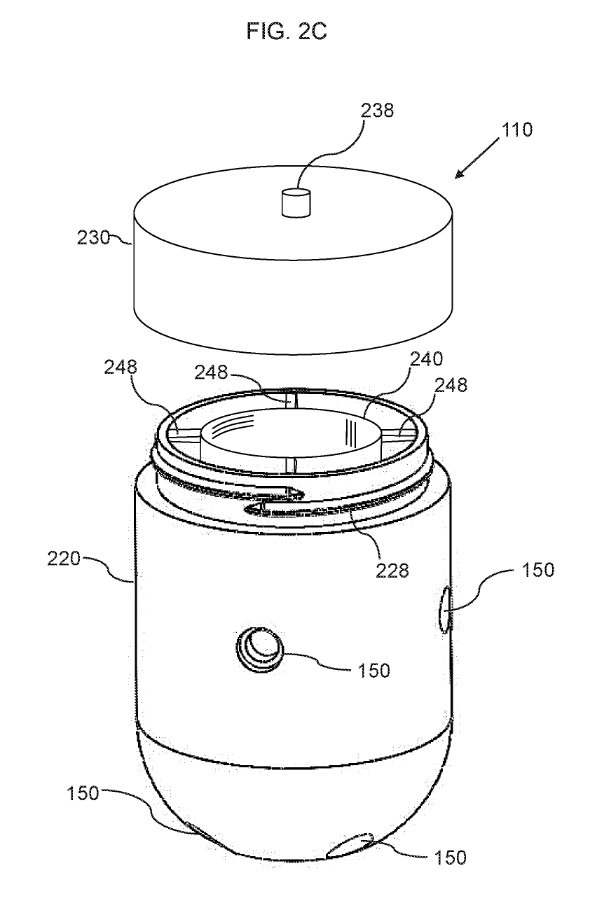

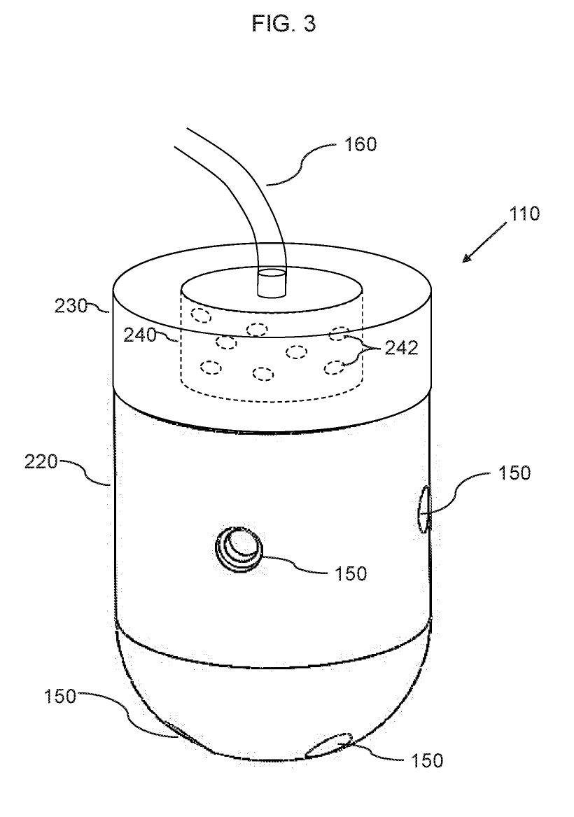

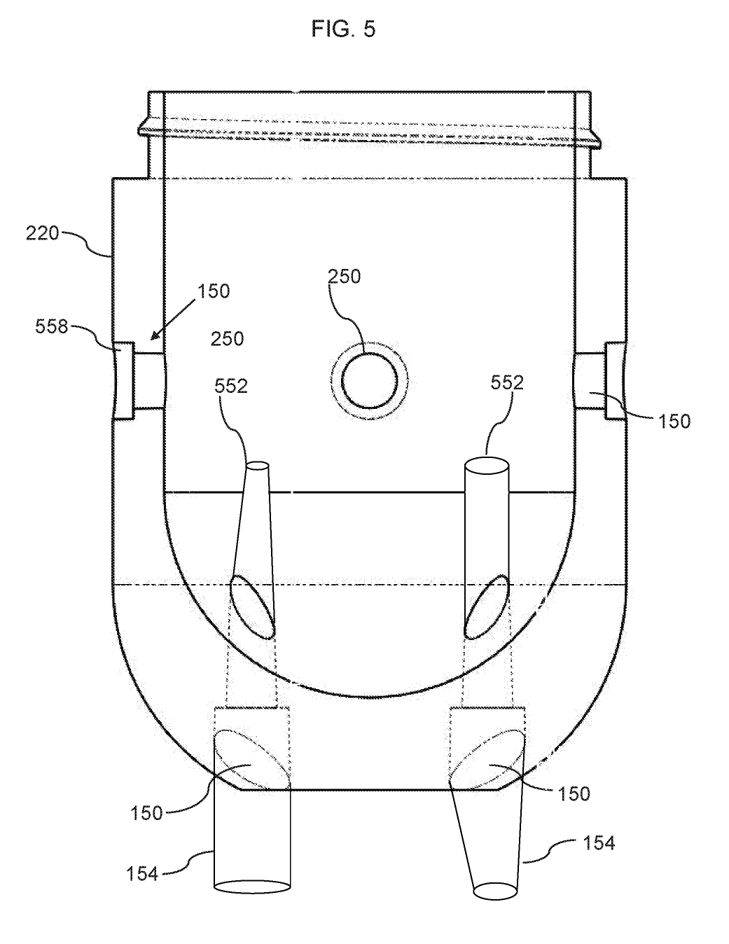

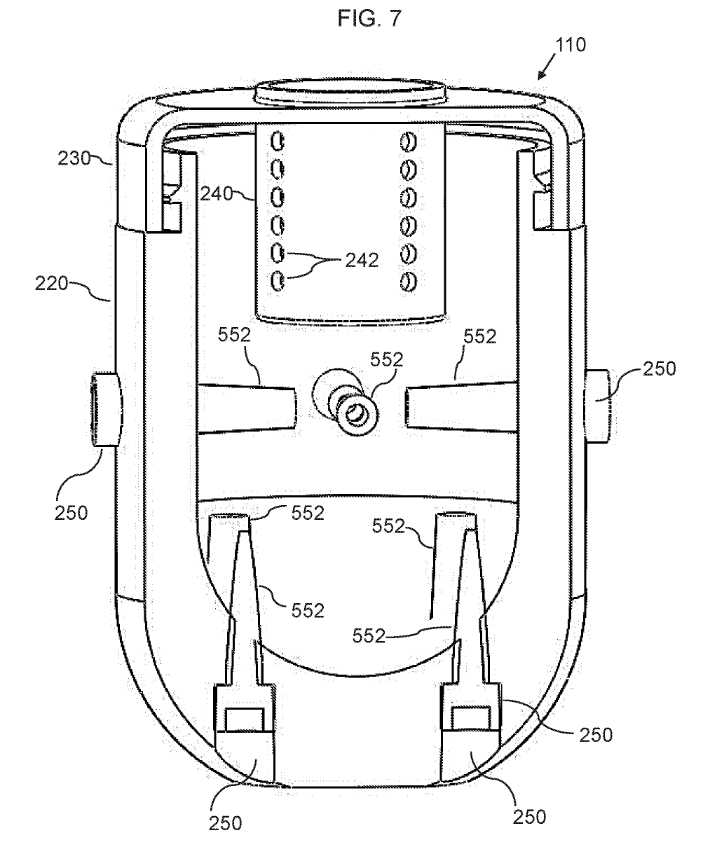

In various embodiments, as shown in FIGS. 1A, 1B, 2A, 2B, 2C, 3, 4, 5, 6, 7, 8A, and 8B, a bristle worm trap 100 for catching bristle worms 104 in an aquarium 102, can include:
a) A trap body 110, including:
   i. a trap enclosure 220, as shown in FIGS. 2A and 2B, which is configured with an upper aperture 222 that leads into an enclosure cavity 224;
   ii. a cap 230, which is removably positioned on an upper part of the trap enclosure 220, such that the cap 230 covers the upper aperture 222, and closes the enclosure cavity 224;
   iii. a bait container 240, which can be mounted inside the trap body 110, wherein the bait container 240 comprises a plurality of container apertures 242, which are configured to distribute a scent from a bait/attractant 244 that is placed inside the bait container 240, such that the scent is distributed to the enclosure cavity 224;
   iv. At least one or a plurality of worm access points 150, which are entry apertures in the trap enclosure 220, which provide access from an external environment to the enclosure cavity 224, such that bristle worms 104 crawl through the access points 150, guided by the scent from the bait 244, and become trapped in the trap enclosure 220; wherein each worm access point 150, can further include:
      an inner access line 552, as shown in FIGS. 5, 6, and 7, which is hollow and connects to an inner side of the worm access points 150, such that the bristle worms 104 crawl through the inner access line 552 into the trap enclosure 220, such that the inner access line 552 prevent the bristle worms from escaping the trap enclosure 220; and
      an outer access line 154, which is hollow and connects to an outer side of the worm access points 150, such that the bristle worms crawl through the outer access line 154 and then trough the inner access line 552, to reach the trap enclosure 220; and
b) An elongated handle 160, which is connected to the trap body 110, such that the elongated handle 160 is flexible and configured to allow positioning of the trap body 110 in the aquarium 102.

In a related embodiment, the elongated handle 160 can be a plastic tube, which can be hollow, and can further be transparent, such as flexible plastic tubes commonly used to pump air and water in aquariums. Alternatively, the elongated handle 160 can be a solid plastic stick.

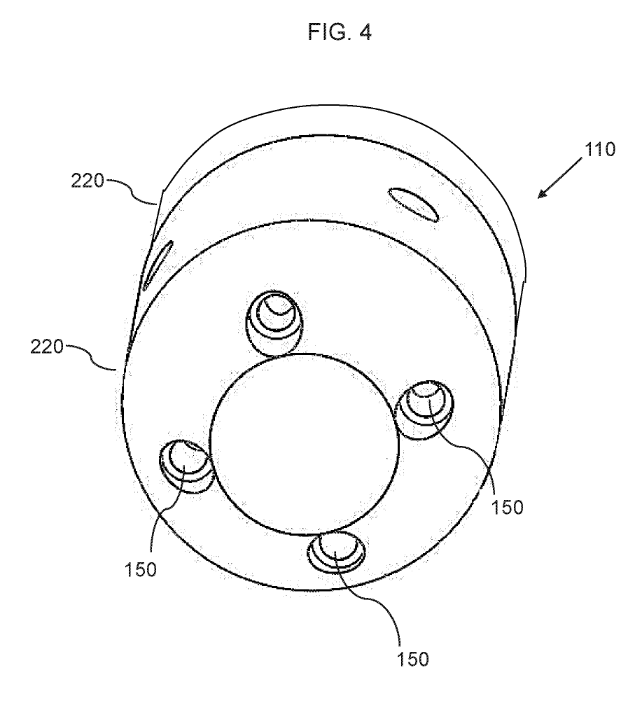

In other related embodiments, as shown in FIGS. 1A and 1B, the bristle worm trap 100 can be used to trap mainly bristle worms 104, or other types of worms 104, in a reef tank 102, such that the bristle worm trap 100 is easily placed anywhere in the tank without a need for users having to insert and get their hands wet. As shown in FIG. 1B, the bristle worm trap 100 can be placed on or near live rocks 106 or any place where bristle worms 104 have been observed. As shown in FIG. 2A, when the bristle worm trap 100 is positioned on a live rock 106, or other place where bristle worms 104 are observed, some or all of the lower worm access points 150, as shown in FIG. 4, can be used without an outer access line 154 mounted, such that the worms can crawl directly into the worm access points 150, which are positioned adjacent to the live rock 106.

In further related embodiments, as shown in FIG. 1, an outer access line 154, can be configured as an elongated outer access tube 154, with a length of at least 2, 3, 4, 5, 8, 10, 12, 15 or more inches, in order to reach particular areas, such as for example a live rock 106. Such an elongated outer access tube 154 can help catch particularly large bristle worms that are too long to fully enter the enclosure cavity 224, such that they instead are trapped in the elongated outer access tube 154, in some cases with a front part of the bristle worm inside the enclosure cavity 224.

In a related embodiment, as shown in FIGS. 2A and 2B, the bait container 240 can be mounted in the cap 230.

In yet a related embodiment, as shown in FIGS. 2A, 2B, and 2C the cap 230, can be removably positioned on the upper part of the trap enclosure 220, with a screw closure 228.

In yet another related embodiment, as shown in FIGS. 2A and 2B the cap 230, can further include a bait lid 236, which can be removably positioned on the upper part of the cap 230, such that:
a) the bait lid 236 closes the bait container 240, as shown in FIG. 2A, when the bait lid 236 is placed on the upper part of the cap 230, to close an opening to the bait container 240; and
b) removal of the bait lid 236, as shown in FIG. 2B, provides access to an interior of the bait container 240.

In a further related embodiment, the bait lid 236 can further comprise a handle attachment point 238, mounted on an upper side of the bait lid 236, such that the handle 160 can be configured to attach to the handle attachment point 238, for example by sliding over and onto the handle attachment point 238.

In another related embodiment, as shown in FIG. 2C, the bait container 240 can be mounted in the trap enclosure 220, in an upper part of the enclosure cavity 224, for example with mounting connectors 248, which connect between the trap enclosure 220 and the bait container 240.

In a further related embodiment, as shown in FIG. 2C, the cap 230 can further comprise a handle attachment point 238, mounted on an upper side of the cap 230, such that the handle 160 can be configured to attach to the handle attachment point 238, for example by sliding over and onto the handle attachment point 238.

In other related embodiments, the bristle worm trap 100 can be made in a plastic material. The bristle worm trap 100 can be made with a suitable thickness of the plastic to have the proper weight, such hat the bristle worm trap 100 does not move under water, such that the bristle worm trap 100 is sufficiently light to sit on top of corals, without damaging the corals.

In a related embodiment, as shown in FIG. 5, a worm access point 150, can further include an access indentation 558, which can be configured to accept an outer access line 154.

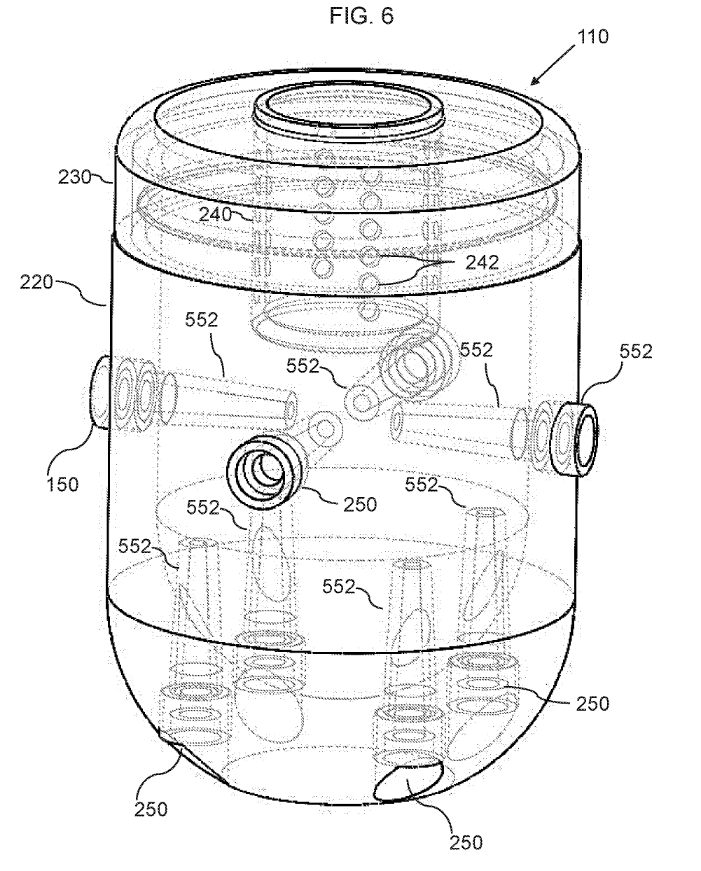

In related embodiment, as shown in FIGS. 5 and 6, the worm access point 150 can be flush with the trap enclosure 220 or it can protrude from the trap enclosure 220.

In a related embodiment, as shown in FIG. 5, an inner access line 552, can be hollow with different elongated shapes, such that the inner access line 552 for example can be configured as:
a) an inner access funnel 552, wherein the inner access funnel 552 is funnel-shaped with a decreasing internal diameter towards an inner end; or
b) an inner access tube 552, wherein the inner access tube 552 is tube-shaped with a uniform internal diameter.

In a related embodiment, as shown in FIG. 5, an outer access line 154, can be hollow with different elongated shapes, such that the outer access line 154 for example can be configured as:
a) an outer access funnel 154, wherein the outer access funnel 154 is funnel-shaped with a decreasing internal diameter towards an outer end; or
b) an outer access tube 154, wherein the outer access tube 154 is tube-shaped with a uniform internal diameter.

In another related embodiment, as shown in FIG. 2A, a top of the trap body 110, such as a top of the cap 230, can further include a plurality of ventilation apertures 232, which are configured to permit ventilation of air inside the trap body 110, when the trap body 110 is inserted into water 108 of an aquarium, as shown in FIGS. 1A and 1B.

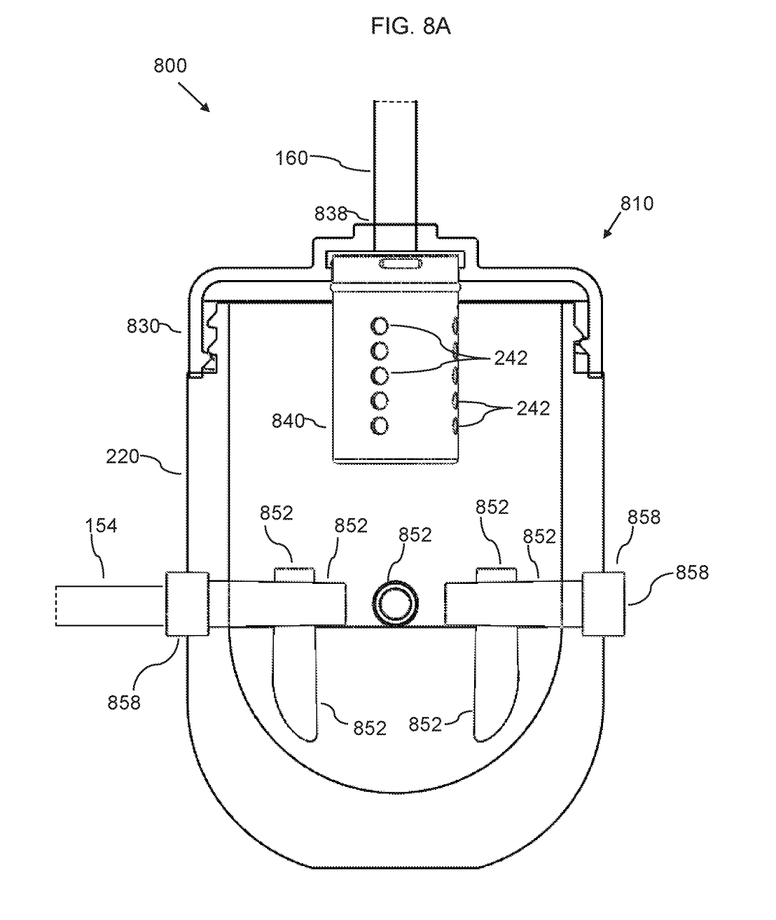

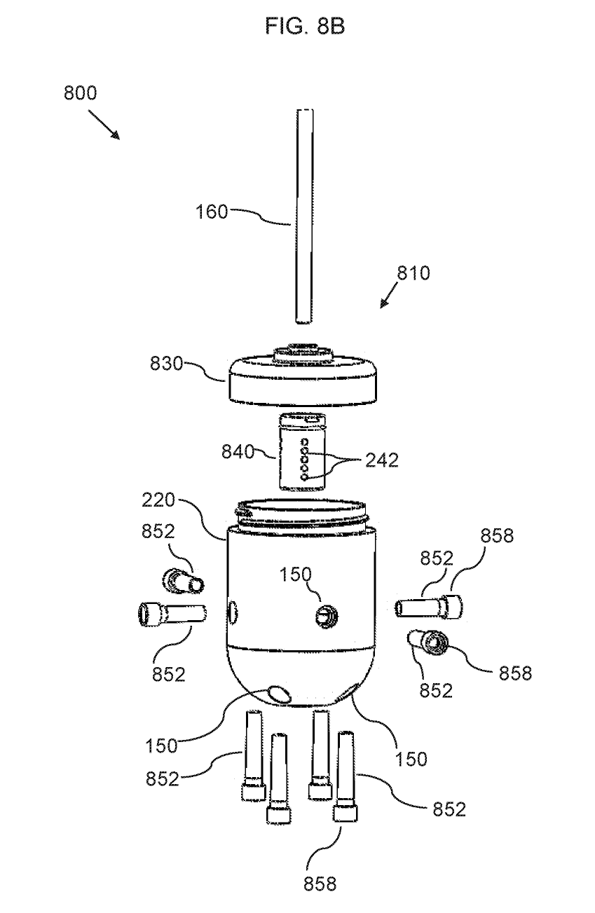

In a related alternative embodiment, FIGS. 8A and 8B, show a configuration of a bristle worm trap 800, including a trap body 810, wherein:
a) the bait container 840 is removably connected to the cap 830 on a lower side of cap 830;
b) the handle attachment point 838 can be mounted on an upper side of the cap 830;
c) wherein inner access lines 852, can be configured as inner access funnels 852, which further include an outer mounted access indentation 558 or access mount 858 for attaching an outer access line 154, such that each inner access funnel 852 is inserted through a worm access point 150, which can also be referred to as an enclosure aperture 150.

Here has thus been described a multitude of embodiments of the bristle worm trap 100, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A bristle worm trap for catching bristle worms in an aquarium, comprising:
a trap body, comprising:
a trap enclosure, which comprises an enclosure cavity;
at least one worm access point, which comprises an entry aperture in the trap enclosure, wherein the at least one worm access point is configured to provide access from an external environment to the enclosure cavity, such that the bristle worms crawl through the at least one worm access point, guided by a scent from a bait positioned in the trap body, and become trapped in the trap enclosure; wherein the at least one worm access point further comprises:
an inner access line, which is hollow and connected to an inner side of the entry aperture, such that the bristle worms crawl through the inner access line into the trap enclosure, such that the inner access line prevents the bristle worms from escaping the trap enclosure.

2. The bristle worm trap of claim 1, wherein the trap enclosure is configured with an upper aperture that leads into the enclosure cavity; wherein the trap enclosure further comprises:
a cap, which is removably positioned on an upper part of the trap enclosure, such that the cap covers the upper aperture, and closes the enclosure cavity.

3. The bristle worm trap of claim 1, wherein the trap enclosure further comprises:
a bait container with an opening to an inside of the bait container, such that the bait container is mounted inside the enclosure cavity, wherein the bait container comprises:
a bait that is positioned in the inside of the bait container, and
a plurality of container apertures, which are apertures in the bait container that are configured to distribute a scent from the bait, such that the scent is distributed to the enclosure cavity;
such that the bristle worm is guided by the scent from the bait, when it crawls through the at least one worm access point.

4. The bristle worm trap of claim 1, wherein the trap enclosure further comprises:
an outer access line, which is hollow and connected to an outer side of the entry aperture, such that the bristle worm crawls through the outer access line and then trough the inner access line, to reach the trap enclosure.

5. The bristle worm trap of claim 4, wherein the outer access line is configured as a hollow plastic tube.

6. The bristle worm trap of claim 1, wherein the inner access line is configured as a hollow funnel with a decreasing internal diameter towards an inner end.

7. The bristle worm trap of claim 1, further comprising:
an elongated handle, which is connected to the trap body, such that the elongated handle is flexible and configured to allow positioning of the trap body in the aquarium.

8. The bristle worm trap of claim 7, wherein the elongated handle is a plastic tube.

9. The bristle worm trap of claim 8, wherein the plastic tube is hollow.

10. The bristle worm trap of claim 8, wherein the outer access line is configured as a tube with a length of at least 5 inches.

11. The bristle worm trap of claim 3, wherein the trap enclosure is configured with an upper aperture that leads into the enclosure cavity, wherein the trap enclosure further comprises:
a cap, which is removably positioned on an upper part of the trap enclosure, such that the cap covers the upper aperture, and closes the enclosure cavity;
wherein the bait container is mounted in the cap.

12. The bristle worm trap of claim 11, wherein the cap further comprises a bait lid, which is removably positioned on the upper part of the cap, such that:
a) the bait lid is configured to close the bait container, when the bait lid is positioned on the upper part of the cap, to close the opening to the bait container; and
b) removal of the bait lid is configured to provide access to an interior of the bait container via the opening to the inside of the bait container.

13. A bristle worm trap for catching bristle worms in an aquarium, comprising:
a trap body, comprising:
a trap enclosure, which comprises:
an enclosure cavity;
at least one worm access point, which comprises an entry aperture in the trap enclosure, wherein the at least one worm access point is configured to provide access from an external environment to the enclosure cavity, such that the bristle worms crawl through the at least one worm access point, and become trapped in the trap enclosure; and
a bait container with an opening to an inside of the bait container, such that the bait container is mounted inside the enclosure cavity, wherein the bait container comprises:
the bait that is positioned in the inside of the bait container, and
a plurality of container apertures, which are apertures in the bait container that are configured to distribute a scent from the bait, such that the scent is distributed to the enclosure cavity;
wherein the bristle worms are guided by the scent from the bait, when they crawl through the at least one worm access point.

14. The bristle worm trap of claim 13, wherein the at least one worm access point further comprises:
an inner access line, which is hollow and connected to an inner side of the entry aperture, such that the bristle worms crawl through the inner access line into the trap enclosure, such that the inner access line prevents the bristle worms from escaping the trap enclosure.

15. The bristle worm trap of claim 13, wherein the trap enclosure is configured with an upper aperture that leads into the enclosure cavity; wherein the trap enclosure further comprises:
a cap, which is removably positioned on an upper part of the trap enclosure, such that the cap covers the upper aperture, and closes the enclosure cavity.

16. The bristle worm trap of claim 13, wherein the trap enclosure further comprises:
a bait container with an opening to an inside of the bait container, such that the bait container is mounted inside the enclosure cavity, wherein the bait container comprises:
a bait that is positioned in the inside of the bait container, and
a plurality of container apertures, which are apertures in the bait container that are configured to distribute a scent from the bait, such that the scent is distributed to the enclosure cavity;
such that the bristle worm is guided by the scent from the bait, when it crawls through the at least one worm access point.

17. The bristle worm trap of claim 13, wherein the trap enclosure further comprises:
an outer access line, which is hollow and connected to an outer side of the entry aperture, such that the bristle worm crawls through the outer access line and then trough the inner access line, to reach the trap enclosure.

18. The bristle worm trap of claim 14, wherein the inner access line is configured as a hollow funnel with a decreasing internal diameter towards an inner end.

19. The bristle worm trap of claim 13, further comprising:
an elongated handle, which is connected to the trap body, such that the elongated handle is flexible and configured to allow positioning of the trap body in the aquarium.

20. The bristle worm trap of claim 19, wherein the outer access line is configured as a tube with a length of at least 5 inches.
